(19) United States
(12) Patent Application Publication
(10) Pub. No.: US 2014/0058960 A1
(43) Pub. Date: Feb. 27, 2014

(54) PREDICTIVE MODELING: LITIGATION DECISION ANALYSIS AND OPTIMIZATION

(71) Applicant: DataCert, Inc., Houston, TX (US)

(72) Inventors: Rashad Wallace Porter, Cypress, TX (US); Rachit Lal, Houston, TX (US); Bennetta Marie Trahan, Houston, TX (US)

(73) Assignee: DATACERT, INC., Houston, TX (US)

(21) Appl. No.: 14/011,614

(22) Filed: Aug. 27, 2013

Related U.S. Application Data
(60) Provisional application No. 61/693,695, filed on Aug. 27, 2012.

(51) Int. Cl. G06Q 50/18; G06Q 40/00

(52) U.S. Cl. CPC G06Q 50/18; G06Q 40/00
USPC 705/311

(57) ABSTRACT

A method for analyzing a litigation case. The method comprises: receiving a request to analyze a litigation case of a legal matter type and retrieving, in response to the request, a template for the legal matter type including a plurality of legal questions corresponding to a plurality of scenarios associated with the legal matter type. The method also includes receiving, in response to prompting the plurality of questions, a plurality of probabilities and a plurality of estimated financial damages for the litigation case and calculating a case value for the litigation case based on the plurality of probabilities and the plurality of estimated financial damages.

### CROSS-REFERENCE TO RELATED APPLICATIONS

This application claims priority under 35 U.S.C. §119(e) to U.S. Provisional Patent Application No. 61/693,695, entitled: “PREDICTIVE MODELING: LITIGATION DECISION ANALYSIS AND OPTIMIZATION,” which filed on Aug. 27, 2012. Accordingly, U.S. Provisional Patent Application No. 61/693,695 is hereby incorporated by reference in its entirely.

### BACKGROUND

In any type of litigation, there are many possible outcomes. An outcome may include awarded financial damages.

### SUMMARY

In general, in one aspect, the invention relates to a method for analyzing a litigation case. The method comprises: receiving a request to analyze a litigation case of a legal matter type; retrieving, in response to the request, a template for the legal matter type comprising a plurality of legal questions corresponding to a plurality of scenarios associated with the legal matter type; receiving, in response to prompting the plurality of questions, a plurality of probabilities and a plurality of estimated financial damages for the litigation case; and calculating a case value for the litigation case based on the plurality of probabilities and the plurality of estimated financial damages.

In general, in one aspect, the invention relates to a system for analyzing a litigation case. The system comprises: a template repository storing a template comprising a plurality of legal questions corresponding to a plurality of scenarios associated with a legal matter type of the litigation case; a portal for receiving a plurality of probabilities and a plurality of estimated financial damages based on the litigation case and in response to the plurality of legal questions; and a case value engine configured to calculate a case value for the litigation case based on the plurality of probabilities and the plurality of estimated financial damages.

In general, in one aspect, the invention relates to a non-transitory computer readable medium storing instructions for analyzing a litigation case. The instructions comprising functionality for: receiving a request to analyze a litigation case of a legal matter type; retrieving, in response to the request, a template for the legal matter type comprising a plurality of legal questions corresponding to a plurality of scenarios associated with the legal matter type; receiving, in response to prompting the plurality of questions, a plurality of probabilities and a plurality of estimated financial damages for the litigation case; and calculating a case value for the litigation case based on the plurality of probabilities and the plurality of estimated financial damages.

Other aspects of the invention will be apparent from the following description and the appended claims.

### BRIEF DESCRIPTION OF DRAWINGS

FIG. 1 shows a block system diagram in accordance with one or more embodiments of the invention.

FIG. 2 shows a flowchart in accordance with one or more embodiments of the invention.

FIG. 3, FIG. 4A, and FIG. 4B show examples involving decision trees in accordance with one or more embodiments of the invention.

FIGS. 5A-5D show examples involving templates in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

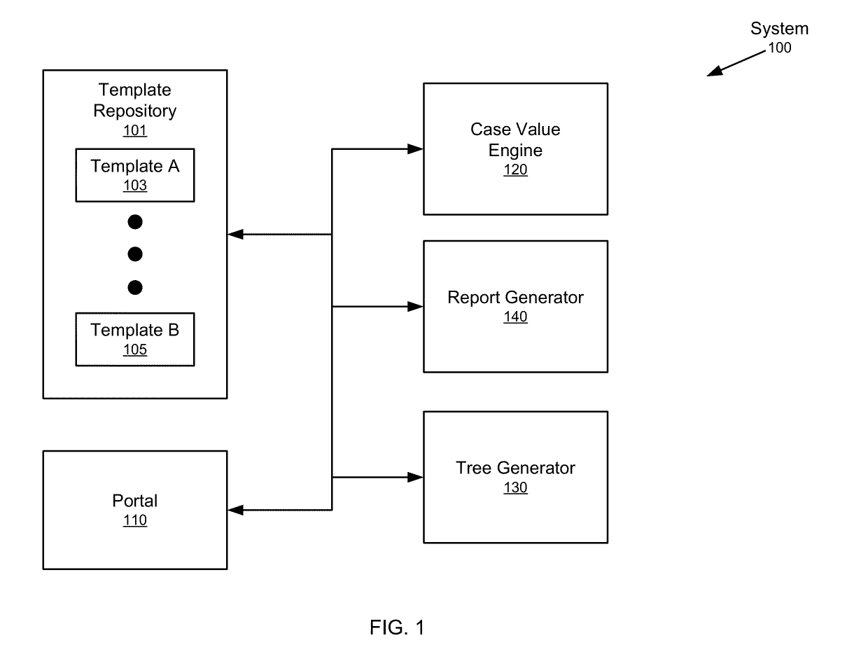

FIG. 1 shows a system (100) in accordance with one or more embodiments of the invention. As shown in FIG. 1, the system (100) may have multiple components including a template repository (101), a portal (110), a case value engine (120), a report generator (140), and a tree generator (130). Each of these components is described below and may be located on the same hardware device (e.g., a server, mainframe, desktop personal computer (PC), laptop, personal digital assistant (PDA), television, cable box, satellite box, kiosk, telephone, smartphone, tablet computer, e-reader, etc.) or may be located on separate hardware devices connected by a network (e.g., the Internet), with wired and/or wireless segments.

In one or more embodiments of the invention, the system (100) includes the template repository (101). The template repository (101) stores one or more templates (e.g., Template A (103), Template B (105)). Each template (103, 105) corresponds to a legal matter type. For example, Template A (103) may correspond to personal injury litigation, while Template B (105) may correspond to patent litigation. Templates may be added, modified, and/or deleted at any time from the template repository (101). For example, new templates may be downloaded from a manufacturer or supplier of the system (100). As another example, one or more templates may be updated by a user of the system (100).

In one or more embodiments of the invention, each template (103, 105) includes multiple questions. The questions in a template may correspond to different possible scenarios, outcomes, events, etc. in the legal matter type of the template. The questions may be true/false, multiple choice, short answer, long answer, etc. The questions may require numerical answers (e.g., probabilities, dollar amounts, etc.). Although “dollar amounts” are used frequently in this detailed description, “dollar amounts” may refer to monetary amounts in any currency. The questions may have a pre-existing sequence/workflow. Some questions may be skipped or repeated depending on the answers to questions earlier in the sequence. One or more questions may be revisited at any time and updated answers may be provided/collected at any time. Moreover, templates may include comments/narratives around the decision path.

In one or more embodiments of the invention, a question interface (not shown) is used to create or modify a question. The question interface allows an administrator (or other user setting up the template) to input/edit the text of a question, input/edit the order of the question in the template sequence, input/edit a long description of the question, input/edit possible answer choices, and input/edit other attributes of the question. In one or more embodiments of the invention, an answer interface (not shown) is used to create or modify answer choices to one or more questions. Specifically, the answer interface allows an administrator (or other user setting up the template) to input/edit answer attributes.

In one or more embodiments of the invention, the system (100) includes the portal (110). The portal (110) may include one or more GUIs with widgets (e.g., labels, textboxes, radio buttons, slides, graphics, text, drop-down lists, tabs, etc.) to facilitate the selection of a template (103, 105), the prompting of the template questions to the user(s), the collection of answers from the user(s), and/or manipulation/editing of a legal decision tree (discussed below). The portal (110) may be operated by various types of users including attorneys, notaries, paralegals, legal secretaries, in-house counsel, outside counsel, the plaintiff, the defendant, a judge, experts, a jury member, insurance carriers (e.g., property and casualty insurance, etc.), an insurance claim settler, a member of the general public, etc. The portal (110) may be used to export questions and/or legal decision trees (discussed below) to different users in any format (e.g., txt files, XML files, tables, spreadsheets, etc.) and/or import new/updated answers to questions from different users. The portal (110) may be used to search legal archives, legal databases, legal libraries, legal websites, etc. for answers (e.g., probabilities, dollar amounts, etc.) to one or more questions. The portal (110) may also be used to create/edit templates. Additionally or alternatively, a separate template portal (not shown) may be used to create/modify templates.

In one or more embodiments of the invention, the case value engine (120) is configured to calculate a case value (e.g., dollar amount) for the litigation based on one or more answers to the questions. The case value engine (120) is configured to re-calculate the case value (e.g., dollar amount) in response to new/updated answers to one or more questions. In the or more embodiments of the invention, the questions cover all possible outcomes of the litigation. Accordingly, the probability of each outcome and the estimated financial damage for each outcome may be derived from the answers to the questions. In one or more embodiments of the invention, the case value is the expected value. In other words, the case value may be calculated by multiplying the probability of an outcome with the estimated financial damage for the outcome, and then summing the product with the products corresponding to other outcomes. Those skilled in the art, having the benefit of this detailed description, will appreciate that the case value may be calculated using any mathematical/statistic algorithm or model.

In one or more embodiments of the invention, the system (100) includes the tree generator (130). The tree generator (130) is configured to generate a legal decision tree based on the questions and answers. Specifically, the legal decision tree includes multiple branches corresponding to different scenarios in the legal matter type. The scenarios may be labeled on the legal decision tree. The probabilities of the scenarios may be labeled on the legal decision tree. The estimated financial damages may be labeled on the legal decision tree. The legal decision tree may include the case value. The legal decision tree may be displayed to, exported to, and/or edited by a user (e.g., via the portal (110)). The user may zoom in to or zoom out from different regions of the legal decision tree. The user may add notes to the legal decision tree. The user may add additional dollar amounts (e.g., sunk costs) to the legal decision tree (e.g., the nodes of the legal decision tree). The additional dollar amounts provided by the user may change the case value of the litigation.

In one or more embodiments of the invention, the system (100) includes the report generator (140). The report generator (140) is configured to generate one or more standard and/or custom reports. Example reports include Report of Counsel's Reasoning, Issue-by-Issue; Decision Analysis Summary Report; Report of Completed Decision Tree; Decision Analysis Comparison Report; and Decision Analysis Optimization Report.

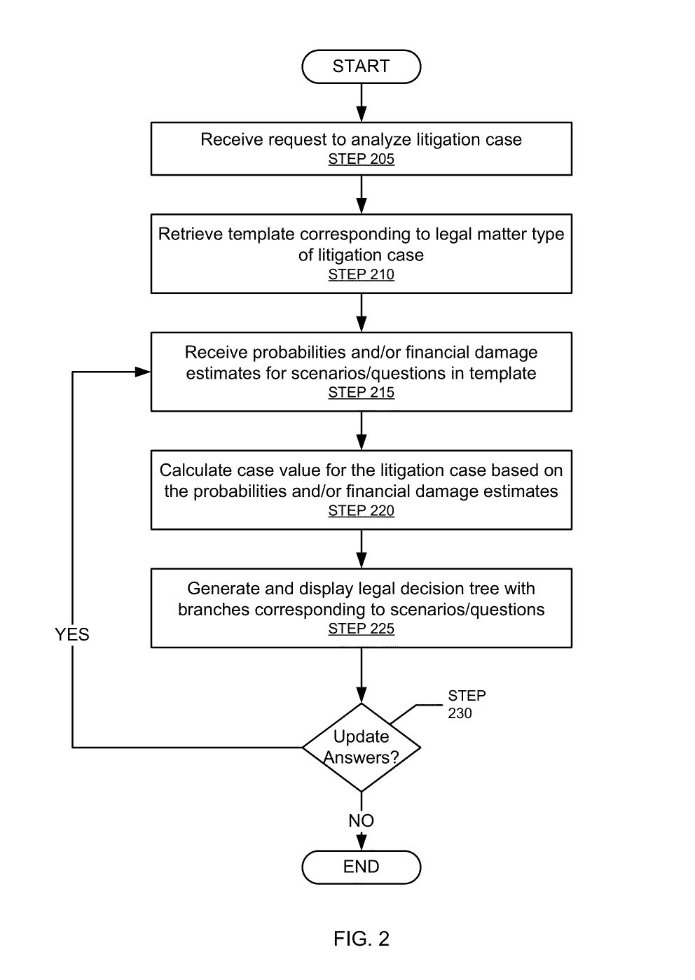

FIG. 2 shows a flowchart in accordance with one or more embodiments of the invention. The process shown in FIG. 2 may be executed, for example, to analyze a litigation case using one or more components of the system (100) (discussed above in reference to FIG. 1). One or more steps shown in FIG. 2 may be omitted, repeated, and/or performed in a different order among different embodiments of the invention. Accordingly, embodiments of the invention should not be considered limited to the specific number and arrangement of steps shown in FIG. 2.

In STEP 205, a request to analyze a litigation case is received. The litigation case may pertain to any legal matter type (e.g., personal injury litigation, patent infringement litigation, etc.). Further, the request may be received from any type of user including attorneys, notaries, paralegals, legal secretaries, in-house counsel, outside counsel, the plaintiff, the defendant, a judge, a jury member, insurance carriers (e.g., property and casualty insurance, etc.), an insurance claim settler, a member of the general public, etc. Further still, the request may be received at any time during the litigation (e.g., before the litigation has started, before the trial by jury has started, before preliminary hearings, etc.).

In STEP 210, a template corresponding to the legal matter type is retrieved. The template may be retrieved from a template repository storing templates for different legal matter types. The template includes multiple questions. The questions in the template correspond to different possible scenarios, outcomes, events, etc. in the legal matter type. The questions may be true/false, multiple choice, short answer, long answer, etc. The questions may require numerical answers (e.g., probabilities, dollar amounts, etc.). The questions may have a pre-existing sequence/workflow. Some questions may be skipped or repeated depending on the answers to questions earlier in the sequence.

In STEP 215, answers to one or more questions in the template are collected from the user. The answers may include probabilities and estimated financial damages corresponding to possible scenarios in the legal matter type. The questions may be prompted to the user via GUIs, and the GUIs may include widgets (e.g., labels, textboxes, radio buttons, slides, graphics, text, drop-down lists, tabs, etc.) to facilitate the collection of answers from the user. The answers to some questions may be provided by a different user (e.g., outside counsel) after the question is exported to the different user. Further, the user may answer questions based on his/her knowledge and experience and/or access legal databases, legal websites, legal opinions, etc. to provide answers to the questions. New/updated answers may be provided at any time. The answers to some questions may be extracted from existing cases handled by the same firm.

In STEP 220, a case value (e.g., dollar amount) for the litigation case is calculated. The case value amount is calculated based on the answers to one or more questions. In one or more embodiments of the invention, the questions cover all possible outcomes of the litigation. Accordingly, the probability of each outcome and the estimated financial damage for each outcome may be derived from the answers to the questions. In one or more embodiments of the invention, the case value is the expected value. In other words, the case value may be calculated by multiplying the probability of an outcome with the estimated financial damage for the outcome, and then summing the product with the products corresponding to other outcomes. Those skilled in the art, having the benefit of this detailed description, will appreciate that the case value may be calculated using any mathematical/statistic algorithm or model.

In STEP 225, a legal decision tree is generated and displayed to the user. The legal decision tree includes multiple branches corresponding to different scenarios in the legal matter type. The scenarios may be labeled on the legal decision tree. The probabilities of the scenarios may be labeled on the legal decision tree. The estimated financial damages may be labeled on the legal decision tree. The legal decision tree may include the case value. The user may add notes to the legal decision tree. The user may add additional dollar amounts (e.g., sunk costs) to the legal decision tree (e.g., the nodes of the legal decision tree). The legal decision tree may be submitted by a law firm (e.g., outside counsel) as part of a bid to represent a party in the litigation.

In STEP 230, it is determined whether updated answers are available for one or more of the questions in the template. When it is determined that updated answers are available, the process returns to STEP 215. Otherwise the process ends.

At any time before, during, and/or after the process described in FIG. 2, one or more standard and/or custom reports may be generated. Example reports include Report of Counsel's Reasoning, Issue-by-Issue; Decision Analysis Summary Report; Report of Completed Decision Tree; Decision Analysis Comparison Report; and Decision Analysis Optimization Report.

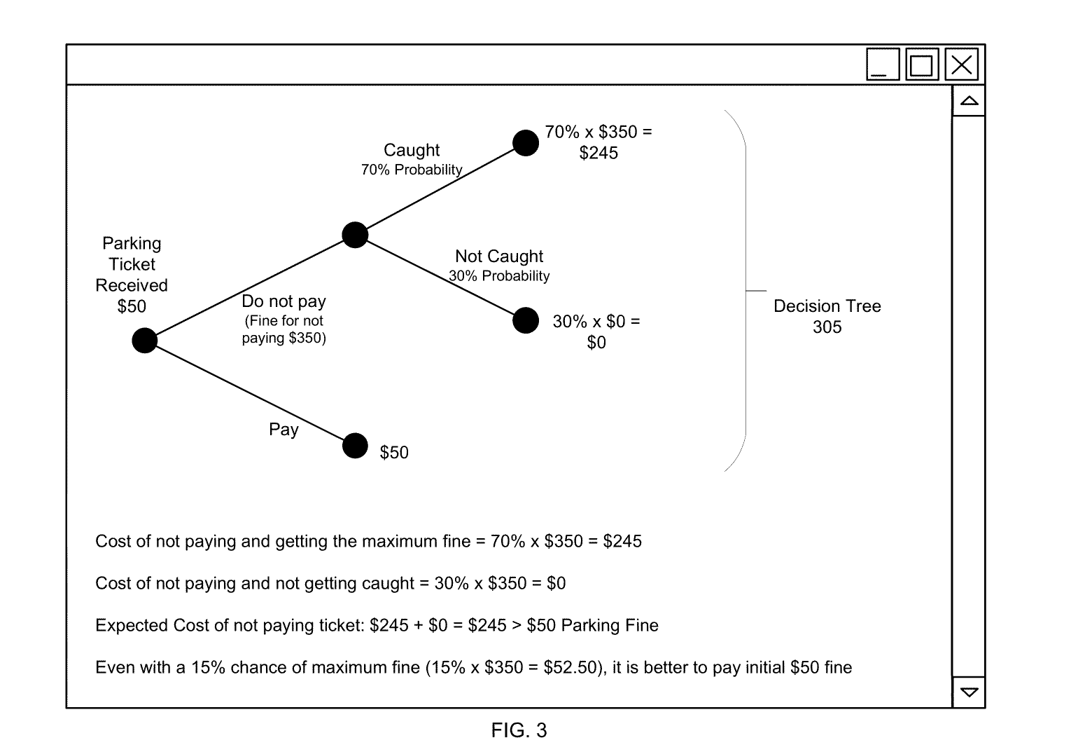

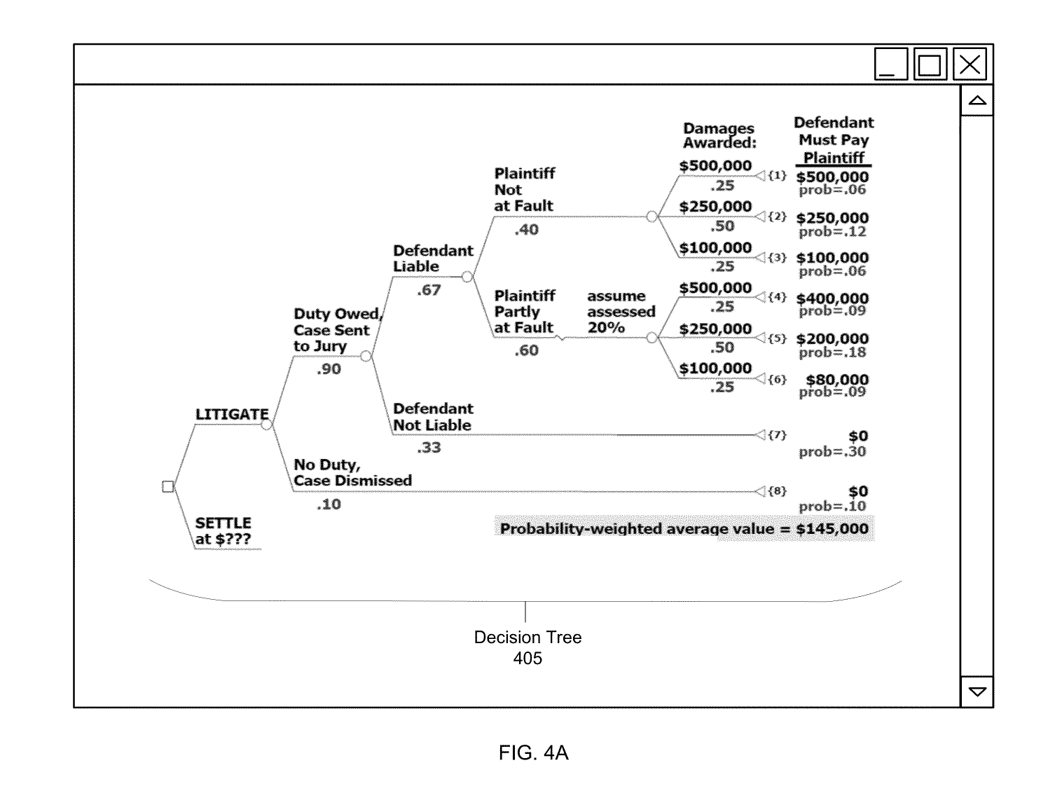

FIG. 3 shows an example in accordance with one or more embodiments of the invention. Specifically, FIG. 3 shows a GUI with a decision tree (305). The decision tree (305) may have been generated by the tree generator (130), discussed above in reference to FIG. 1, and/or via the process described in FIG. 2. As shown in FIG. 3, the decision tree (305) corresponds to a parking ticket with a fine of $50. The decision tree (305) has various nodes, each corresponding to a different scenario. For example, one node corresponds to the scenario in which the parking ticket is simply paid. Another node corresponds to the scenario in which the parking ticket is not paid and the motorist is not caught. Yet another node corresponds to the scenario where the parking ticket is not paid and the motorist is caught and fined $350 for not paying the initial parking ticket. Edges (i.e., branches) between nodes include probabilities corresponding to the various scenarios. The probabilities may be obtained from historical records and/or another outside source (e.g., the Department of Motor Vehicles). The probabilities may be answers to questions of the template dealing with parking tickets. The various expected values/costs may be calculated by the case value engine (120), discussed above in reference to FIG. 1, and/or the process described in FIG. 2. The decision tree (305) helps visualize choices, consequences, probabilities, and opportunities.

FIG. 4A shows an example in accordance with one or more embodiments of the invention. Specifically, FIG. 4A shows a GUI with a decision tree (405). The decision tree (405) may have been generated by the tree generator (130), discussed above in reference to FIG. 1, and/or via the process described in FIG. 2. As shown in FIG. 4A, the decision tree (405) corresponds to a personal injury matter. The decision tree (405) has various nodes, each corresponding to a different scenario. For example, one node corresponds to the scenario in which the defendant is liable, the plaintiff is not at fault, and $250,000 worth of damages are awarded. Another node corresponds to the scenario in which the defendant is not liable. Yet another node corresponds to the scenario where the case is dismissed. Edges (i.e., branches) between nodes include probabilities corresponding to the various scenarios. The probabilities/damages awarded may be obtained from historical court records and/or another source (e.g., attorney inputs). The various expected values/costs may be calculated by the case value engine (120), discussed above in reference to FIG. 1, and/or the process described in FIG. 2. The decision tree (405) also includes a probability-weighted average value of approximately $145,000. In other words, this is the expected dollar amount the defendant must pay plaintiff, based on the probabilities/damages awarded inputs. The decision tree (405) helps visualize choices, consequences, probabilities, and opportunities.

Although the example of FIG. 4A focuses on the Plaintiff Share of Fault, in one or more embodiments of the invention, the template/template questions capture co-defendant Share of Fault and consider this share of fault when calculating the case value. Example additional questions to capture multiple share of fault may include: Will jury find defendant partially liable? Will jury find co-defendant partially liable?

Although the example of FIG. 4A focuses on a single type of damages, various types of damages may be captured. Example types of damages include Economic Damages (e.g., Past/Future Medical Expenses); Non-Economic Damages (e.g., Pain and Suffering); and Punitive Damages. Low, medium, and high values/ranges for each type of damage may also be captured and used to calculate case value. Damage questions may be customized by the user to include past wages, attorney fees, etc.

FIG. 4B shows an example in accordance with one or more embodiments of the invention. Specifically, FIG. 4B shows a GUI with a decision tree (407). As shown in FIG. 4B, the decision tree (407) has nodes corresponding to specific types of damages (e.g., economic, non-economic, and punitive), and low/medium/high values for each type of damage.

Those skilled in the art, having the benefit of this detailed description, will appreciate that it may be necessary to change the formula used to calculate the case value based on the types of damages. One possible formula: Amount Defendant Owes=[Defendant Share of Fault*(Award 1+Award 2+Award 3 . . . )+Punitive, where Award 1=Past Medical Bills, Award 2: Years*Future Wages, Award 3=Market Share Gain*Future Revenues*Margin. Compensatory Awards may be added and multiplied by Defendant Share of Fault. Punitive Damages are added on top of that.

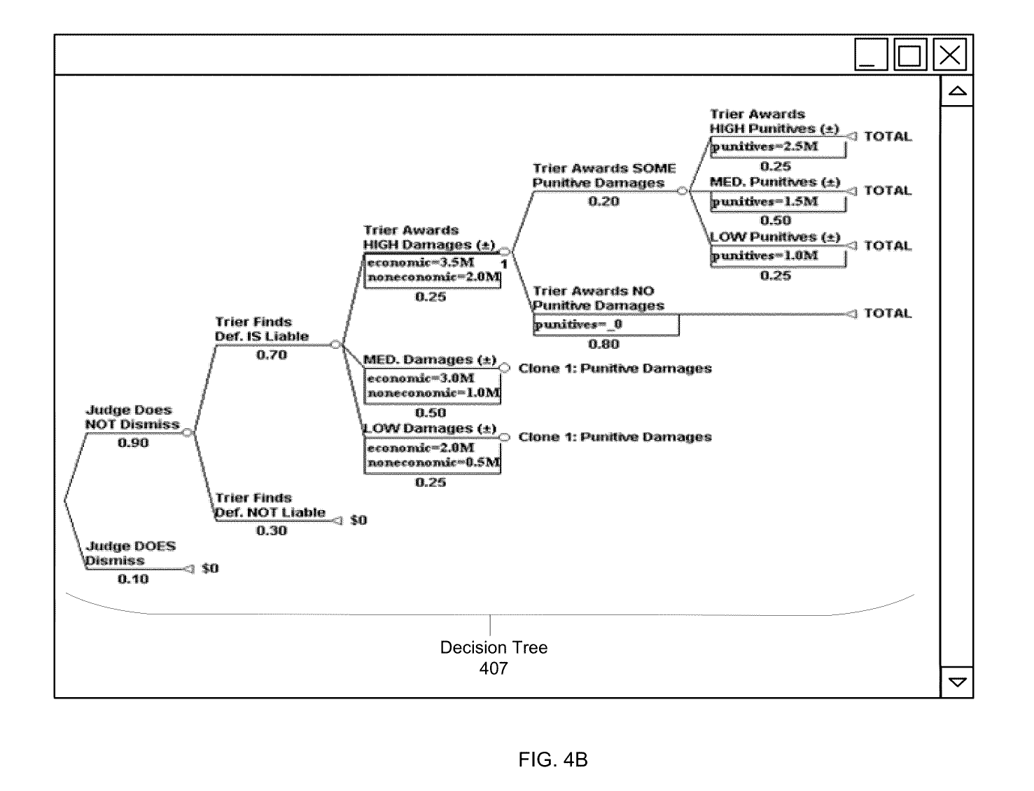

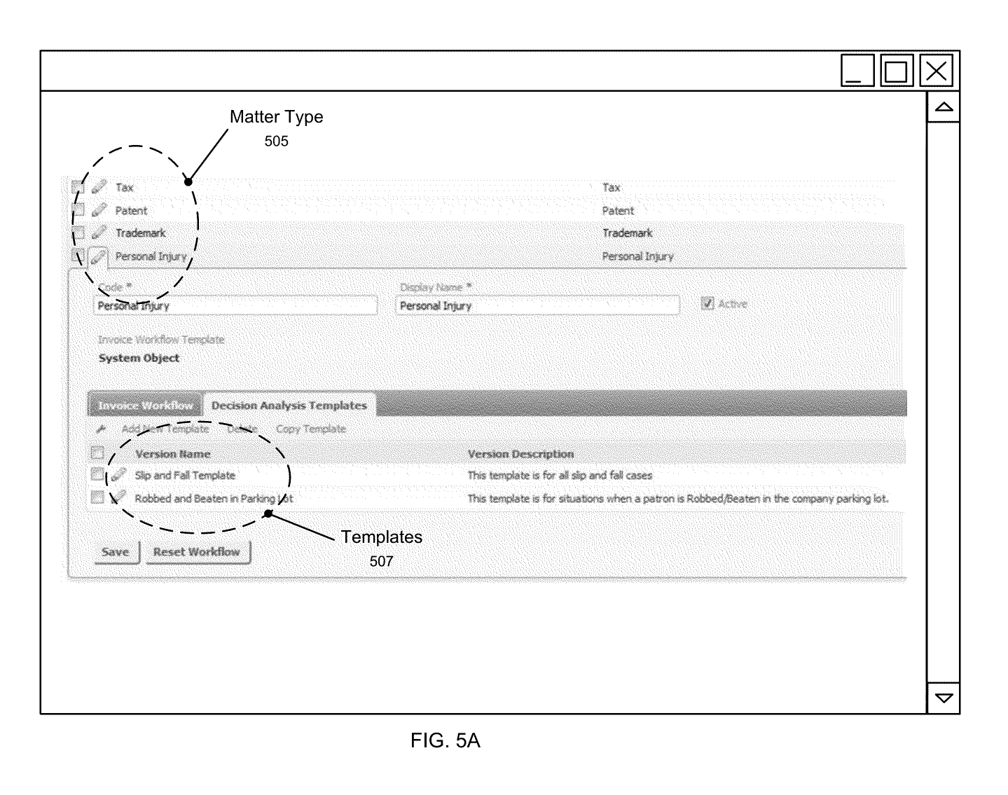

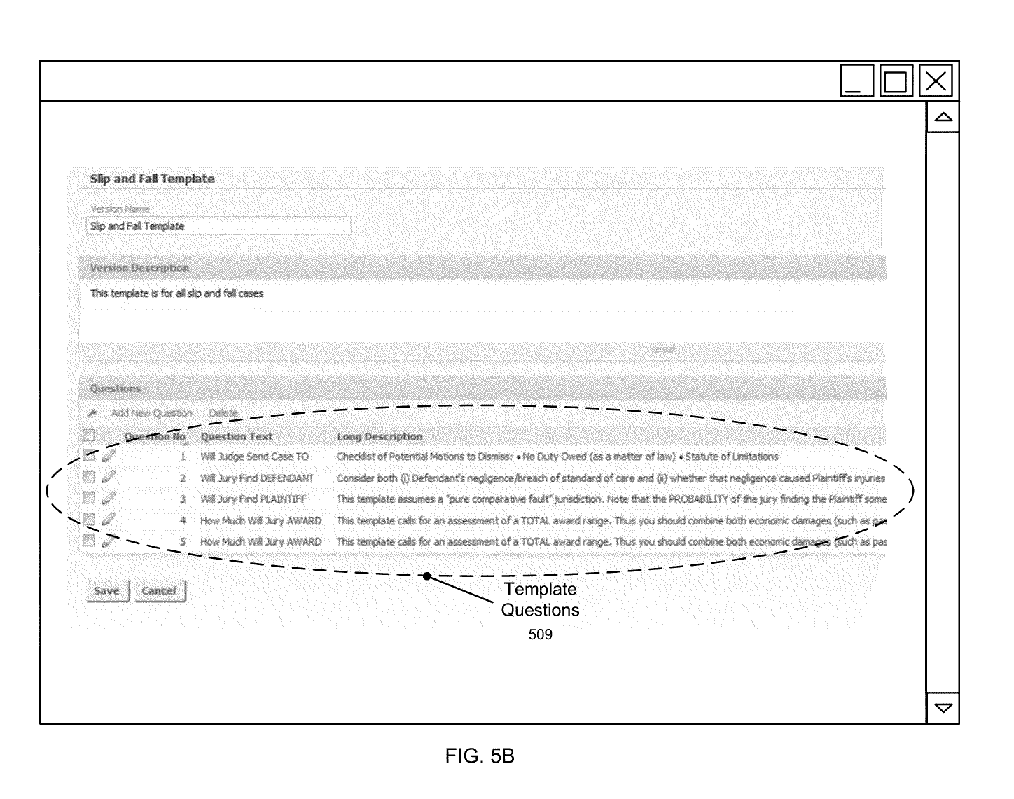

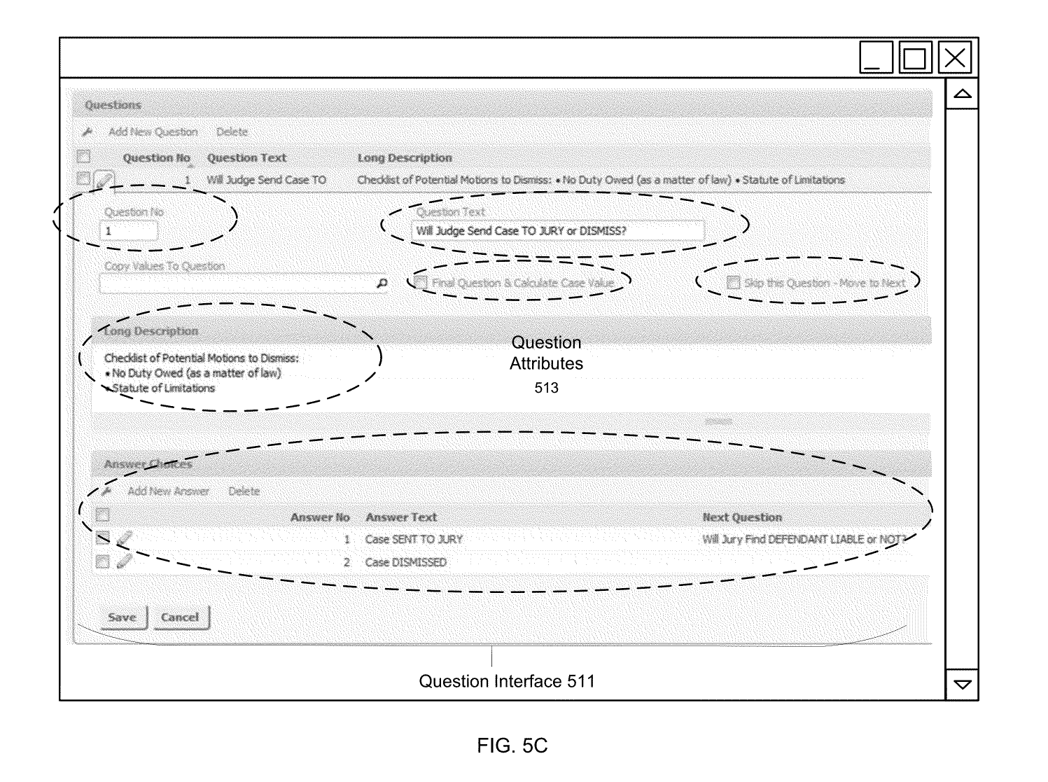

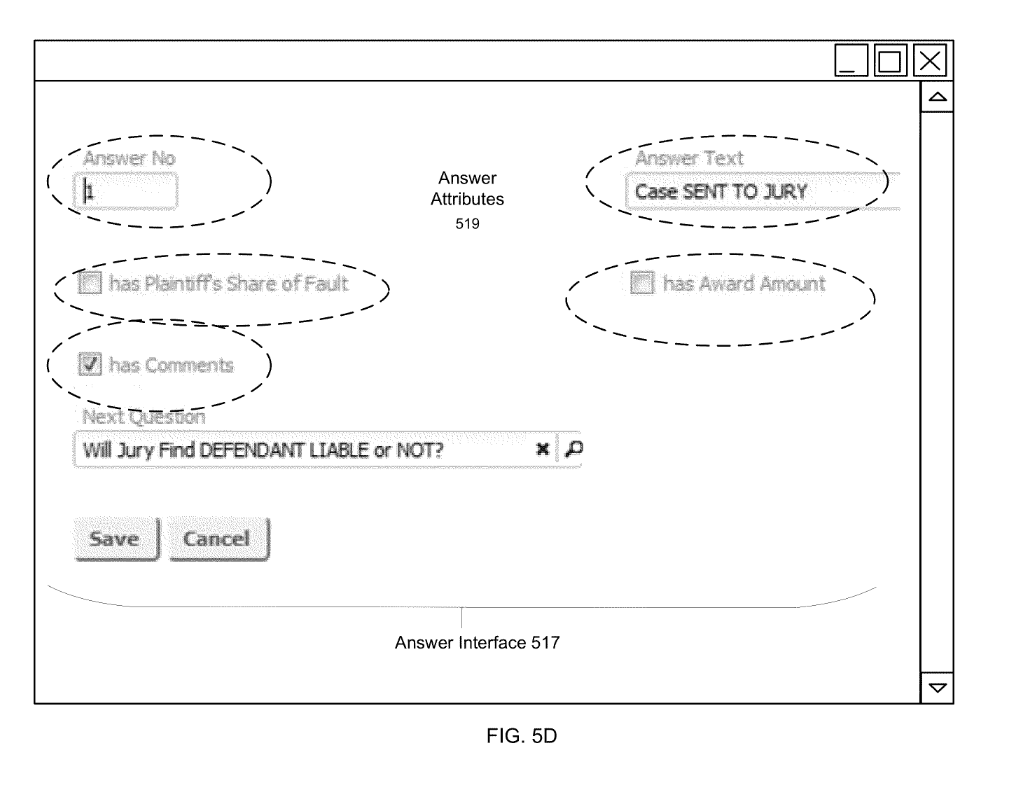

FIGS. 5A-5D show example interfaces in accordance with one or more embodiments of the invention. Specifically, the interfaces shown in FIGS. 5A-5D correspond to templates and the mechanisms to access, create, and/or modify the templates. Accordingly, all of the interfaces shown in FIG. 5A-5D may be components of the portal or template portal discussed above in reference to FIG. 1. In FIG. 5A, matter types (505) are displayed to the user (e.g., an administrator). Example matter types include Tax, Patent, Trademark, Personal Injury, etc. In response to selecting a matter type (505), templates (507) specific to the selected matter type are displayed. In FIG. 5A, the user has selected the personal injury matter type, and the templates corresponding to this matter type (i.e., Slip and Fall Template, Robbed and Beaten in Parking Lot, etc.) are displayed with descriptions. Each template is based on the litigation best practices for a given matter type.

Assume the user selects the Slip and Fall Template. In FIG. 5B, the template questions (509) for the selected template are displayed to the user. As shown in FIG. 5B, both the question text, the long description, and the order of the questions are displayed. In the case of a personal injury legal matter, the questions may include: 1. Will judge send case to JURY? 2. Will JURY find DEFENDANT? 3. Will JURY find PLAINTIFF? 3a. PLAINTIFF at fault? 3b. PLAINTIFF partly at fault? 4. How much will JURY AWARD? 4a. High Damages. 4b. Medium Damages; 4c. Low Damages. Now assume the user selects question number 1. FIG. 5C shows the question interface (511) for question number 1. As shown in FIG. 5C, question interface (511) displays multiple question attributes (513) for question number 1. In the question interface (511), the user may modify/update one or more of the question attributes (513) for question number 1. Question attributes (513) may be modified/updated by inputting text in textboxes, checking or unchecking boxes, selecting items out of drop-down lists, etc. One of the question attributes (513) includes answer choices. Each answer choice corresponds to a possible answer to question number 1. By saving the modification/updates to the question attributes (513), the question and the template are updated. Now assume the user selects answer choice number 1.

FIG. 5D shows the answer interface (517) for answer choice number 1. As shown in FIG. 5D, the answer interface (517) displays multiple answer attributes (519) for answer choice number 1. In the answer interface (517), the user may modify/update one or more of the answer attributes (519) for answer choice 1. Answer attributes (519) may be modified/updated by inputting text in textboxes, checking or unchecking boxes, selecting items out of drop-down lists, etc. By saving the modification/updates to the answer attributes (519), the answer and the template are updated.

In one or more embodiments of the invention, the system (100) of FIG. 1, the process of FIG. 2, and the GUIs shown in the various examples are a tool(s) that enable professionals to make better legal/business decisions leveraging historical results. For example, the tool(s) may help answer questions including: How much to offer to settle? Whether I should accept a settlement or go to trial? How much should I reserve? Whether I have selected the best outside counsel? Are my expectations realistic regarding: likelihood of win or loss? What damages might be awarded? How much will it cost? How long will it (e.g., trial) take?

In one or more embodiments of the invention, the system (100) of FIG. 1, the process of FIG. 2, and the GUIs shown in the various examples are a tool(s) that calculate litigation probabilities and total case value based on inputs from legal professionals. The tool(s) allow for: better decision analysis by accessing case value early and rigorously; what-if modeling by varying liability and damage assessments to see how case value and strategy are affected; and predictive optimization by using historical matter and firm performance when accessing potential outcome.

In one or more embodiments of the invention, the system (100) of FIG. 1, the process of FIG. 2, and the GUIs shown in the various examples are a tool(s) that are used to realistically communicate expectations for key matters, reduce surprises, obtain better settlements, and manage overall risk (e.g., set reserves). This is especially helpful for general counsel and associate general counsel. The tool(s) will help improve case strategies and quantify litigation risk throughout the matter lifecycle. This is especially helpful for attorneys including outside counsel. The tool(s) provides the legal department a standard mechanism for estimating the total risk across the portfolio of matters. This is especially useful for legal operations managers.

Embodiments of the invention include one or more of the following advantages: the ability to attach templates to any matter type; the ability to allow outside counsel to provide continuous case value updates and assessments via a collaboration portal; the ability to enable quick real-time recalculation of case value, etc.

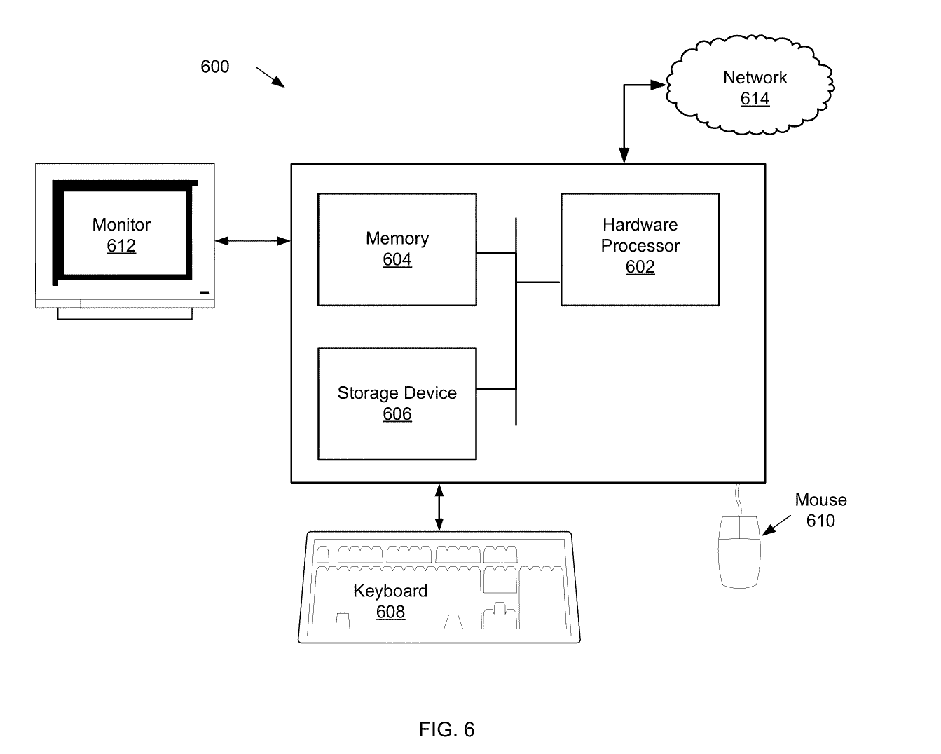

Embodiments of the invention may be implemented on virtually any type of computer regardless of the platform being used. For example, as shown in FIG. 6, a computer system (600) includes one or more processor(s) (602), an associated memory (604) (e.g. random access memory (RAM), cache memory, flash memory, etc.), a storage device (606) (e.g. a hard disk, an optical drive such as a compact disk drive or digital video disk (DVD) drive, a flash memory stick, etc.), and numerous other elements and functionalities typical of today's computers (not shown). In one or more embodiments of the invention, the processor (602) is hardware. For example, the processor may be an integrated circuit. The computer system (600) may also include input means, such as a keyboard (608), a mouse (610), or a microphone (not shown). Further, the computer system (600) may include output means, such as a monitor (612) (e.g. a liquid crystal display (LCD), a plasma display, or cathode ray tube (CRT) monitor). The computer system (600) may be connected to a network (614) (e.g. a local area network (LAN), a wide area network (WAN) such as the Internet, or any other type of network) via a network interface connection (not shown). In one or more embodiments of the invention, many different types of computer systems exist, and the aforementioned input and output means may take other forms. Generally speaking, the computer system (600) includes at least the minimal processing, input, and/or output means necessary to practice embodiments of the invention.

Further, in one or more embodiments of the invention, one or more elements of the aforementioned computer system (600) may be located at a remote location and connected to the other elements over a network. Further, embodiments of the invention may be implemented on a distributed system having a plurality of nodes, where each portion of the invention (e.g. the computing device, the multifunction printer) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, a tape, memory, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
receiving a request to analyze a litigation case of a legal matter type;
retrieving, in response to the request, a template for the legal matter type comprising a plurality of legal questions corresponding to a plurality of scenarios associated with the legal matter type;
receiving, in response to prompting the plurality of questions, a plurality of probabilities and a plurality of estimated financial damages for the litigation case; and
calculating a case value for the litigation case based on the plurality of probabilities and the plurality of estimated financial damages.

2. The method of claim 1, further comprising:
displaying a legal decision tree comprising a plurality of branches corresponding to the plurality of scenarios.

3. The method of claim 2, further comprising:
sending, by outside counsel, the legal decision tree to a potential client.

4. The method of claim 1, wherein the legal matter type is personal injury.

5. The method of claim 1, further comprising:
exporting at least one of the questions to outside counsel for an answer.

6. The method of claim 1, wherein calculating the case value comprises:
generating a plurality of products by multiplying the plurality of financial damages and the plurality of probabilities; and
summing the plurality of products.

7. The method of claim 1, further comprising:
modifying the template by modifying a property of at least one question of the plurality of questions.

8. A non-transitory computer readable medium storing instructions, the instructions comprising functionality for:
receiving a request to analyze a litigation case of a legal matter type;
retrieving, in response to the request, a template for the legal matter type comprising a plurality of legal questions corresponding to a plurality of scenarios associated with the legal matter type;
receiving, in response to prompting the plurality of questions, a plurality of probabilities and a plurality of estimated financial damages for the litigation case; and
calculating a case value for the litigation case based on the plurality of probabilities and the plurality of estimated financial damages.

9. The non-transitory computer readable medium of claim 8, the instructions further comprising functionality for:
displaying a legal decision tree comprising a plurality of branches corresponding to the plurality of scenarios.

10. The non-transitory computer readable medium of claim 9, the instructions further comprising functionality for:
sending, by outside counsel, the legal decision tree to a potential client.

11. The non-transitory computer readable medium of claim 8, wherein the instructions for calculating the case value comprise functionality for:
generating a plurality of products by multiplying the plurality of financial damages and the plurality of probabilities; and
summing the plurality of products.

12. The non-transitory computer readable medium of claim 8, the instructions further comprising functionality for:
modifying the template by modifying a property of at least one question of the plurality of questions.

13. A system for analyzing a litigation case, comprising:
a template repository storing a template comprising a plurality of legal questions corresponding to a plurality of scenarios associated with a legal matter type of the litigation case;
a portal for receiving a plurality of probabilities and a plurality of estimated financial damages based on the litigation case and in response to the plurality of legal questions; and
a case value engine configured to calculate a case value for the litigation case based on the plurality of probabilities and the plurality of estimated financial damages.

14. The system of claim 13, further comprising:
a tree generator configured to build a legal decision tree comprising a plurality of branches corresponding to the plurality of scenarios.

15. The system of claim 13, wherein the portal is accessible to outside counsel, and wherein outside counsel provides at least one of the plurality of probabilities and the plurality of estimated financial damages.

16. The system of claim 13, further comprising:
a template portal configured to modify the template.

17. The system of claim 16, wherein the template portal comprises:
a question interface having a plurality of widgets to modify a plurality of question attributes; and
an answer interface configured to modify an answer choice of a question of the plurality of questions.

18. The system of claim 13, wherein the case value engine is configured to calculate the case value by:
generating a plurality of products by multiplying the plurality of financial damages and the plurality of probabilities; and
summing the plurality of products.

19. The system of claim 13, wherein the legal matter type is patent litigation.

20. The system of claim 13, further comprising a form generator configured to generate a plurality of forms.
